(19) United States
(12) Patent Application Publication
(10) Pub. No.: US 2003/0066252 A1
(43) Pub. Date: Apr. 10, 2003

(54) Gate arrangement for closure of a passageway between rooms with markedly different temperatures

(75) Inventor: Petra Rejc, Landshut (DE)

Correspondence Address: COHEN, PONTANI, LIEBERMAN & PAVANE, 551 FIFTH AVENUE, SUITE 1210, NEW YORK, NY, 10176, US

(73) Assignee: Efaflex Tor-und Sicherheitssysteme GmbH & Co. KG

(21) Appl. No.: 10/266,896

(22) Filed: Oct. 8, 2002

(30) Foreign Application Priority Data
Oct. 9, 2001 (DE) 10149802.0

(51) Int. Cl. E06B 9/00; A47H 23/06

(52) U.S. Cl. 52/173.2; 52/2.17; 160/332; 432/64

(57) ABSTRACT

A gate arrangement for closure of a passageway between rooms with markedly different temperatures, such as the passageway of a freezer-room. Two door curtains are arranged parallel to one another, with each being capable of closing the passageway independently of the other. The door curtains have an abutting insulating air buffer between them, wherein at least one of the door curtains can be motor-driven at such a speed that it is suitable as a temporary high-speed closure between successive passages or transits therethrough. The two door curtains together with the insulating air buffer develop the insulation effect required to maintain the desired cooling temperature. Thus, frequent stocking of the room is possible while compromise of the climate in such rooms during stocking operations is kept to the minimum possible.

### FIELD OF THE INVENTION

The invention relates to a gate arrangement for closure of a passageway between rooms with markedly different temperatures such as the passageway to a freezer room.

### BACKGROUND OF THE INVENTION

The use of a sliding door that is insulated is well-known as an external closure for freezer rooms or other climate-controlled rooms. The insulation effect developed by the sliding door corresponds essentially to the insulation effect of the external walls of the climate-controlled room, so that when the door is in the closed state there exists a uniformly insulated room, in which goods to be cooled such as, for example, foodstuffs or the like, can be stored.

The sliding door must be opened for stocking or removal of goods from the climate-controlled room. However, particularly in the case of doors of the type that are heavy and thus can be actuated only slowly, this results in an exchange of air between the inside of the climate-controlled room and the surroundings that compromises the stability of the climate in said room. This problem is aggravated especially when the climate-controlled room is frequently accessed or trafficked by conveyance or transport equipment. In order to compensate for the resulting undesirable changes in climate, the climate-control equipment such as refrigeration units must be operated at higher output when the sliding door is open. A supplementary unit is frequently provided for this purpose in order to assure that the stored products do not become unusable. A significant additional energy expenditure is connected therewith. In addition, the invading warm and humid air results in an additional load on the refrigeration units, because the precipitating moisture freezes on the cooler surfaces and considerably reduces the cooling performance of the refrigeration unit.

In order to counter this, it is further well-known to arrange ancillary closure within the climate-controlled room, such as a strip curtain, a swinging door, or a folding door on the inside of the sliding door. The cold-lock formed in this manner is clearly an improvement in preventing air circulation between the inside of the climate-controlled room and the surroundings.

This arrangement, too, has been shown to be fraught with drawbacks. Thus, it has been shown that, after the sliding door is opened, the warm surrounding air meets the strip curtain, etc. and there, due to the temperature difference, condenses on the two sides of the curtain strips. This results in a significant accumulation of moisture or to the formation of ice on the strip curtain and the floor area lying thereunder. When this happens, the function of the strip curtain is significantly impaired. In particular, the formation of ice in the floor area represents an obstacle and a hazard when entering the climate-controlled room. In-order to counter this, said floor area is in part heated. Thus, however, the climate in the concerned room is once again negatively affected, since said heating device consequently, for example, counteracts the effect of the refrigeration units. Ultimately, this leads to an appreciably increased energy expenditure for controlling the climate of the room.

Similar problems were found also in the construction type, in which instead of a strip curtain or the like a roller door is arranged inside of the climate-controlled room. In this regard, for example, DE 298 21 157 U1 discloses a cold-lock with a hinged door as the external closure and a roll-up door in the inside area. Here, the ice formation on the cover sheeting of the roll-up door resulted in that the door could no longer be easily rolled up. In this system, in order to maintain the function of the roll-up door at least the tracks and preferably also the cover sheeting are heated. Here too, the ice formation in the floor area under the roll-up door is eliminated by floor heating. In this system, the sum of heating assemblies and the minimal insulation capacity of the cover sheets resulted in extraordinarily high heat energy being added to the climate-controlled room in order to keep the lock ready for operation. High energy losses are connected herewith.

In order to avoid such problems, door assemblies are also well-known, in which roll-up doors or the like are arranged outside of the climate-controlled room and thus also outside of the sliding door. With an open sliding door the interface with the maximal temperature difference occurs not in the interior of the climate-controlled room but outside in the area of the roll-up door. This system has the drawback that consequently the climatewise uncontrolled (warm) air present between the sliding door and the external side of the roll-up door on opening the sliding door results in a compromise of the climate in the room. The essential reason why this system has hardly gained a footing in practice is, however, another problem. As a rule, the free available space in front of such a climate-controlled room is minimal. Frequently, such a refrigerated room or the like is adjacent to a loading dock or similar at which delivery vehicles dock in order to offload or take on the goods to be refrigerated. Moreover, transport equipment such as, for example, forklifts must have the possibility of maneuvering. Therefore, this system is rarely implemented.

Furthermore, these strip curtains, swinging doors or roll-up doors intended as ancillary closures are not suitable on their own for providing an adequate insulation effect for the climate-controlled room. They can be used when the climate-controlled room is stocked or supplied over a limited time and not all too often.

In this context, however, ongoing logistic efforts are moving increasingly in the direction of keeping storage time to a minimum in order to economize corresponding space capacities. Meanwhile, therefore, the stocking or supplying frequencies for such climate-controlled rooms are very high. Since the ancillary closures such as a strip curtain or the like described above are, however, not suitable for use as a permanent closure for the passageway of the climate-controlled room and since the conventional sliding door itself is relatively slow to actuate, these circumstances demand new solutions.

Thus, the transition has been made to configure said sliding doors so that they can be actuated at high speed. In the event of short stocking or supplying breaks, the sliding door can then be closed, without thereby substantially compromising the stocking or supplying process. An alternative solution provides for the configuration of a highly insulating and sectional door operating at high speed. However, these systems have a number of drawbacks. For example, these doors require, especially the guide assemblies, considerable space laterally or over the passageway of the climate-controlled room. Since the available space in said area is limited, this is to be viewed as problematic in practice. Furthermore, such a hinged door or a door panel of this type represents a considerable weight. As this heavy weight is accelerated and decelerated over curved tracks, the inertia involved leads to non-static, i.e. dynamic, forces that occur in high-speed operation which are difficult to manage. A further requirement for high-speed operation is that the tracks and possibly even the door panel sections, for example, are heated by heating elements so that they remain free of ice. Otherwise unforeseen operational conditions could occur.

A further reason why such systems are viewed with skepticism in practice is that damage to the insulating gate arrangement could have devastating consequences for the climate in the insulated room. Thus, it can happen that such a high-speed gate arrangement may not promptly open and may be damaged by a loading vehicle such as a forklift or the like and that complete closure of the climate-controlled room can no longer be established. Even if in many embodiments an ancillary closure using a strip curtain or the like is provided, it is generally not possible to provide the required insulation effect in order to maintain the climate in the room. This is an extremely critical situation for the operator of such a climate-controlled room, since in the time to repair of the damaged door, high economic losses occur due to the destruction of the stored goods. Here is where the requirements for high-speed opening of the door and reliable assurance of the climate in the insulated room are at odds.

### SUMMARY OF THE INVENTION

One object of the invention is to provide a gate arrangement for closure of a passageway between rooms with extremely different temperatures, such as the passageway of a freezer room, which on the one hand allows high frequency stocking or supplying of the room and on the other hand keeps compromise of the climate in such a room to the minimum possible.

This and other objects are attained in accordance with one aspect of the invention directed to a gate arrangement comprising two parallel door curtains that are displaceable independently and so disposed as to close the passageway. The door curtains have an insulating air buffer therebetween, and at least one of the door curtains can be driven by a motor at such speed that it is suitable as a provisional high-speed closure of the passageway between successive passages. The two door curtains together with the insulating air buffer develop the required insulation effect to maintain the cold temperature.

### BRIEF DESCRIPTION OF THE DRAWINGS

FIG. 1 shows a schematic representation of a gate arrangement according to a first embodiment of the invention.

FIG. 2 shows a schematic representation of a gate arrangement according to a second embodiment.

FIG. 3 represents a variant embodiment of the gate arrangement according to the invention.

FIG. 4 represents yet another embodiment of the gate arrangement according to the invention.

FIG. 5 represents a diagram that shows the mean heat transfer coefficients as a factor of the density of the insulating air buffer.

FIG. 6 represents a diagram that shows moisture content as a factor of the temperature of the insulating air buffer.

FIG. 7 represents a diagram that shows the condensation water formation on the slats as a factor of the outside temperature and the inside temperature.

### DETAILED DESCRIPTION OF THE DRAWINGS

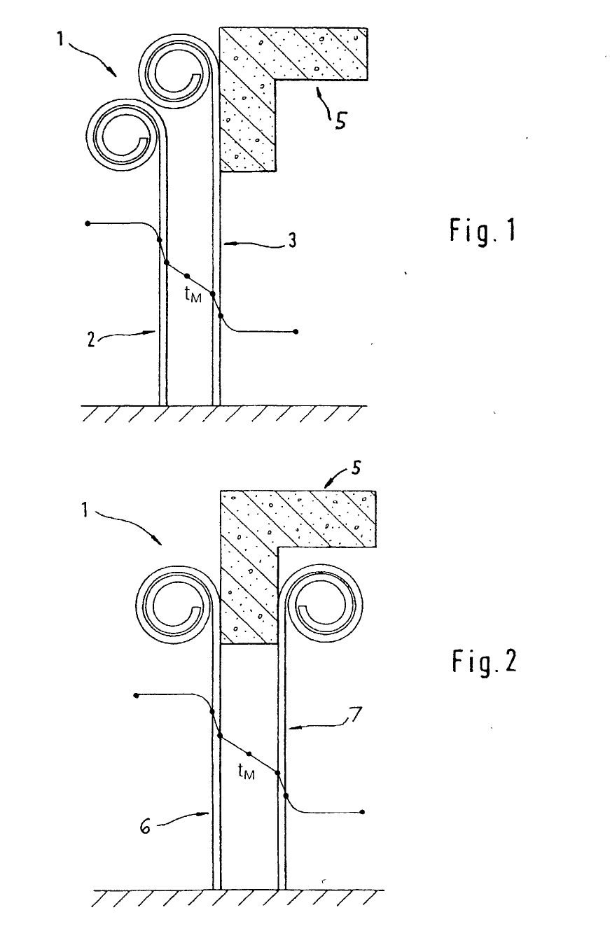

According to the representation in FIG. 1, a gate arrangement 1 comprises an outer door curtain 2, an inner door curtain 3 and an insulating air buffer disposed therebetween.

The door curtains 2 and 3 each comprise a plurality of hinged slats that are connected with one another as well as a foot plate (not shown here in detail) for closure at the floor. In the course of the opening operation, the door curtains 2, 3 are rolled up into a spiral, which is advanced over lateral tracks. Overlapping elements of the curtain within the spiral do not touch each other (i.e. are contactlessly wound). A preferred embodiment for such door curtains is disclosed in U.S. Ser. No. 10/119,506 filed Apr. 10, 2002, which is hereby incorporated herein by reference. Such application discloses an industrial door or gate whose door curtain comprises double-walled slats, wherein the slat walls each are thermally separated in order to limit thermal transfer over the slats so that zones with substantially different ambient temperatures can be separated from one another.

By virtue of the configuration of the door curtains 2 and 3 from a plurality of double-walled slats, in which the interspaces between the slats are filled particularly with a foamed plastic for the purpose of increasing the insulating effect, they exhibit predefined thermal insulation properties. Furthermore, the two door curtains 2 and 3 are integrated into the frame in such a fashion (not shown in FIG. 1), that in the closed state of the gate arrangement 1 the insulating air buffer disposed therebetween is closed off relative to the surroundings. The door curtains 2 and 3 are accordingly so formed that they can be operated at high speed, such as at a speed of 3 m/s. The structure for integrating each of door curtains 2 and 3 into the frame can be as shown in FIG. 1 of the above-mentioned U.S. Ser. No. 10/119,506.

The overall insulation of the gate arrangement 1 thus results in cooperation of the respective insulating function of the door curtains 2 and 3 and the insulating air buffer disposed therebetween.

For stocking or supplying a refrigerated room indicated by portions of the door lintel 5 in FIG. 1, the inner door curtain 3 is firstly opened and remains protectedly coiled in the spiral in the door lintel until completion of the stocking operation. The outer door curtain 2 is opened for passage or transit in the course of the individual stocking processes of the storage room and—in so far as is reasonable or possible—closed again. Since, on opening, the door curtains 2 and 3 are contactlessly wound in the spiral guide, any ice formation, even if present, generally does not result in an impairment of said movement process.

In the event that the outer door curtain 2 is damaged in the course of stocking of the storage room, then the inner door curtain 3, which is meanwhile protected in the spiral in the door lintel, is closed so that by virtue of its own thermal insulating function at least a temporarily effective closure can be established for the climate-controlled storage room.

As a rule, the stocking procedure of the storage room will be accomplished without incident and the gate arrangement 1 will again be completely closed. The insulating effect that can be obtained with the gate arrangement 1 can be seen in the temperature curve inset in FIG. 1. At the gate arrangement 1, for example, temperatures can be from −30° C. in the storeroom and +30° C. in the open surroundings, while a dewpoint t_{M} is present in the insulating air buffer.

In FIG. 2, a modified embodiment 1A of the invention is schematically represented in which the two door curtains 6 and 7 are arranged on the two sides of a door lintel 5. The further details of the door curtains 6 and 7 as well as their function correspond to the arrangement shown in FIG. 1.

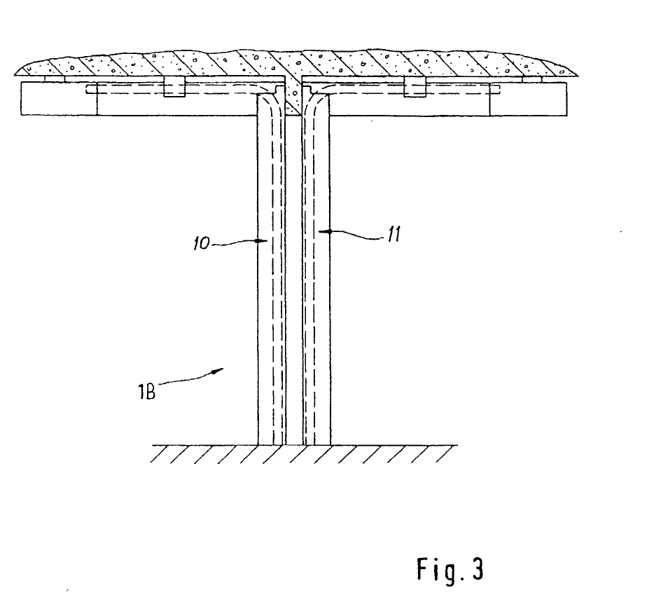

FIG. 3 shows another embodiment of the gate arrangement 1B, wherein the door curtains 10 and 11 are diverted in the lintel zone of the passageway and are not coiled up into a spiral. This system is particularly well-suited in the case of passages between two rooms that are climate controlled, wherein different temperatures are set for each room.

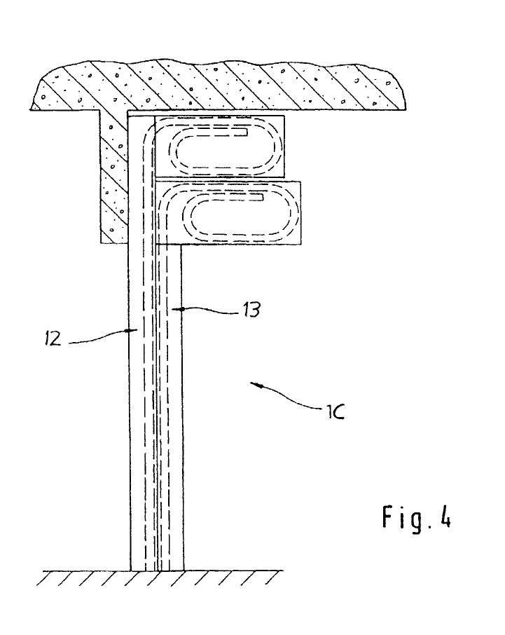

FIG. 4 represents a further modification of the gate arrangement 1C, wherein the door curtains 12 and 13 each are arranged on the inside of the door lintel and are wound up into an elongated coil.

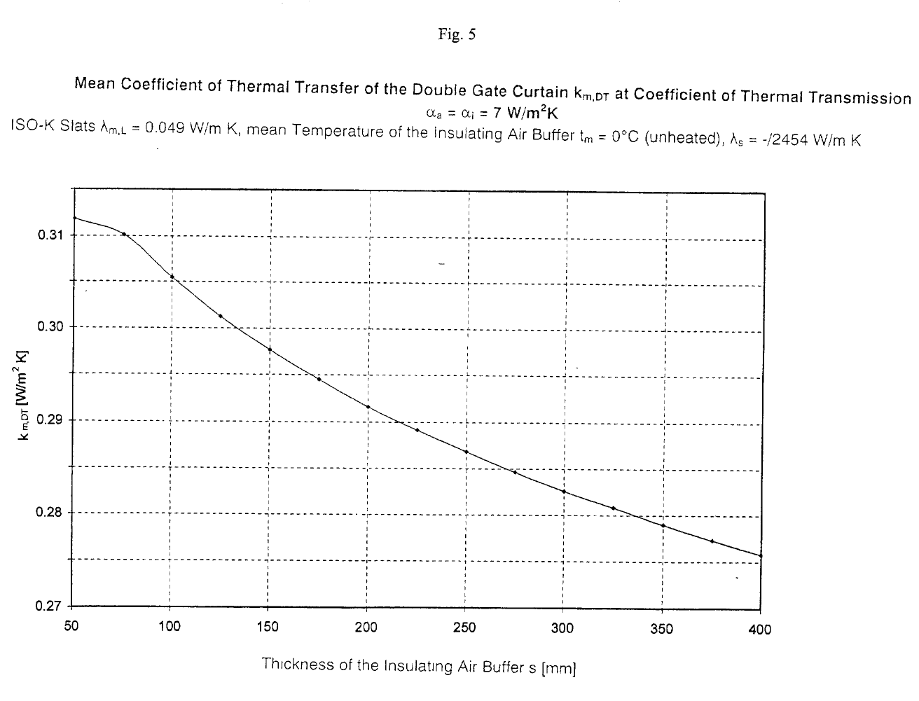

FIG. 5 represents a diagram that indicates the mean thermal transfer coefficients of the double door curtain at a thermal transmission coefficient of the door curtain αₐ=αᵢ=7 W/m²K as a factor of the thickness of the insulating air buffer. Here ISO-K slats with λ_{m,L}=0.049 W/mK is used, wherein the mean temperature of the insulating air buffer was tₘ=0° C. (unheated). From this it is clearly apparent how the mean thermal transmission coefficient decreases with increasing thickness of the insulating air buffer so that a better thermal insulation is achieved.

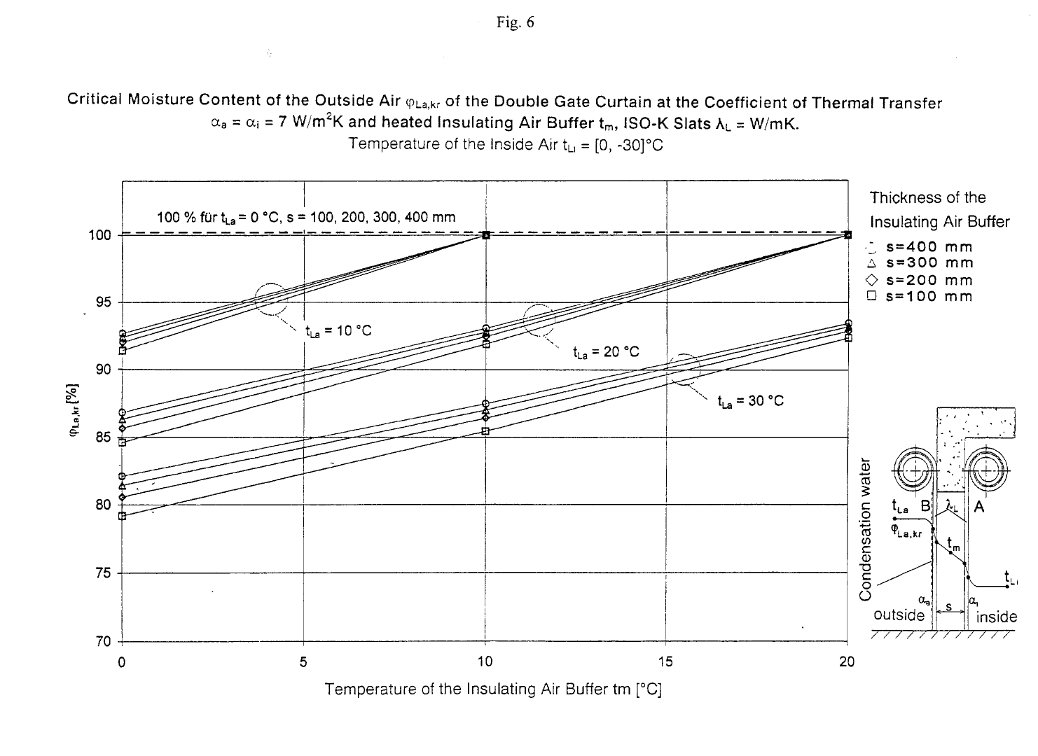

FIG. 6 represents a diagram that indicates the critical moisture content φₖᵣ of the double door curtain at thermal transfer coefficients of αₐ=αᵢ=7 W/m²K and the heated insulating air buffer as a factor of the temperature of the insulating air buffer. Herein the thermal conductivity of the ISO-K slats of λ₁=0.0969 W/mK was incorporated. The critical moisture content curve is indicated for the temperature range of the inside air (t_{Li}) of −30° C. to 0° C., for a different outside air temperature (t_{La}) and different thicknesses of the insulating air buffer(s). As can be seen in this diagram, the risk of formation of condensation water on the door curtain decreases appreciably when the insulating air buffer arranged therebetween is heated to a higher temperature. Heating of the insulating air buffer contributes substantially to prevent the formation of condensation water on the surface of the door curtain. At the critical moisture content φₖᵣ the condensation water forms on those surfaces that abut the outside air.

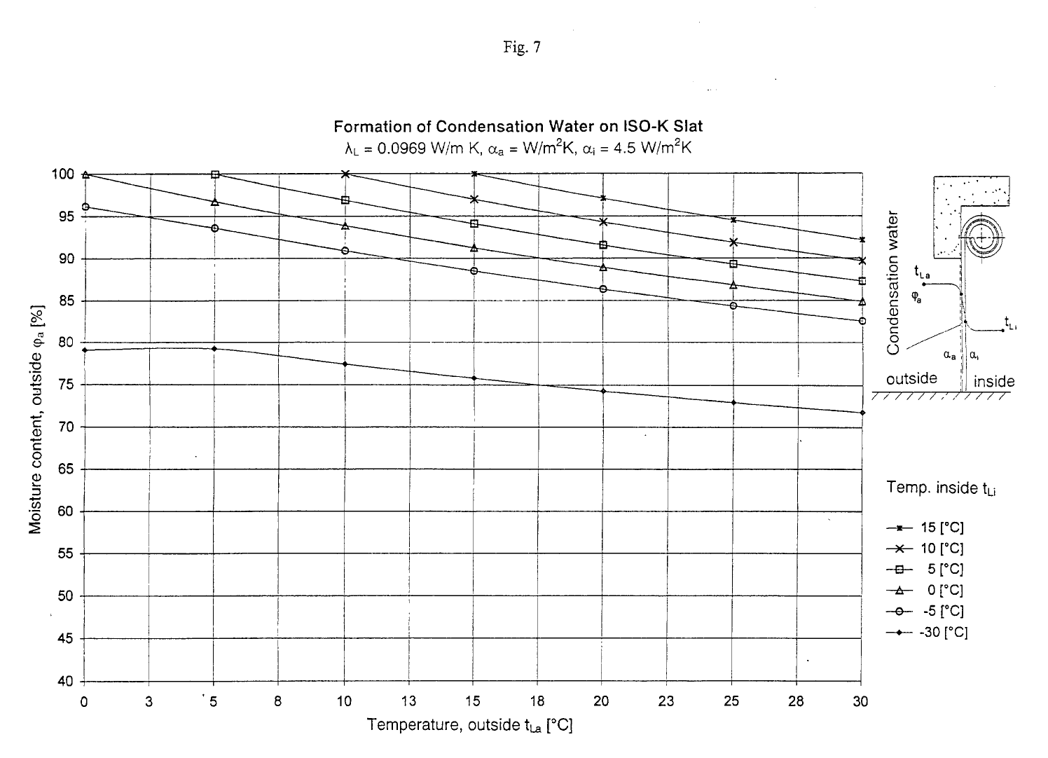

FIG. 7 represents a diagram that indicates condensation water formation on an ISO-K slat as a factor of the outside temperature (t_{La}) and the inside temperature (t_{L1}), wherein the thermal conductivity of the slat λ_{L}=0.0969 W/mK and the surface-heat-transfer coefficient αₐ=10 W/m²K and α₁=4.5 W/m²K. From this it is apparent at which moisture content of the outside air (φₐ) (the critical moisture content) that the condensation water formation starts on the slat surfaces. The condensation water formation is dependent on the outside air temperature (t_{La}) and the inside air temperature (t_{L1}). The condensation water forms on the surface of the slats that abut the outside air.

In addition to the embodiments described hereinabove, the invention can be implemented with other embodiments also. Thus, the door curtains 2 and 3 can also be configured in ways other than those disclosed in the above-mentioned U.S. Ser. No. 10/119,506. Accordingly the two door curtains can, considered each on its own, also develop a low-temperature insulating effect. The door curtains can, for example, be configured also as sectional door curtains. The panels of a sectional door curtain have a height of perhaps 1 meter. This is in comparison with a height of perhaps 10 cm for the slats in the previously described embodiments.

As depicted, the coils of the two door curtains 2 and 3 can be arranged both on one side of the door lintel, separated on opposite sides of the door lintel, or even under the one door lintel. Even combinations of these are possible. Which combination is selected depends on the conditions of utilization; that is, dependent upon what space is available and whether the gate arrangement 1, for example, separates a cold room from the open surroundings, or whether the gate arrangement 1 separates two inside rooms.

Particularly in the case of extreme temperature differences between the two rooms which are separated by the gate arrangement, it is also possible to drive both door curtains 2 and 3 synchronously so that they both together serve as temporary rapid-closures of the passageway between successive passages. Then, there is also the option of a complete external closure of the passageway during stocking, when said passageway is not actually being transited.

Further, it is also possible to selectively control the temperature of the insulating air buffer between the two door curtains 2 and 3 in order to prevent the formation of condensation water and thus the formation of ice on and under the door curtains 2 and 3. In order to do this, for example, air from the inside of the climate-controlled room can be warmed and introduced into the insulating air buffer. The position of the dewpoint t_{M} inside the gate arrangement 1 can be selectively set so as to control the condensation behavior at the gate arrangement 1.

Thus, according to the invention, it is proposed for the first time that the insulating effect for the closure of the passageway of the climate-controlled room is not provided by a single door curtain, but the effect is distributed to a plurality of elements, namely, the two door curtains and the insulating air buffer disposed therebetween. This has the advantage that in the event of emergency even one single door curtain can still serve efficaciously as an ancillary insulation for the climate-controlled room.

With regard to the stocking or supplying operation, this means that one door curtain is constantly opened during the operation, while the other high-speed door curtain is opened for the particular stocking or supplying process. The time in which the passageway of the climate-controlled room is actually standing open can be minimized in this fashion. At the same time the insulation losses in the periods during which at least the one door is closed, can be reduced.

Since the door curtains according to the invention can be moved independently of one another, damage to even to one of them in particular does not result in catastrophic failure of the entire gate arrangement and so to loss of the entire insulation effect. In such an event, an effective emergency closure of the passageway is further made possible by the other door curtain. The gate arrangement according to the invention therefore offers high reliability.

Furthermore according to the invention, in the closed state of the gate arrangement the effect of the insulating air buffer between the two door curtains is effectively used also for insulation, by virtue of which the door curtains can be constructed less massively. They can thus be operated at high speed, whereby high functionality is achieved and in particular the time periods are reduced during which the passageway is completely open. The gate arrangement according to the invention thus contributes substantially to achieving the climate control economically and, in particular, to low energy requirements. At the same time, it offers high functional reliability which is readily obtainable even in the low-temperature cooling range down to −40° C., for example.

The door curtain facing the warmer side of the passageway can serve as a temporary rapid closure. Then the warmer external air abuts the door curtain in all operational states, whereby icing can be reliably avoided.

Further, the two door curtains can be motor-driven at such speed that they are suitable as temporary rapid closures of the passageway between successive passages, wherein the two door curtains can be synchronously driven. Then, between two passages through the passageway one complete closure to the outside can be achieved for the climate-controlled room. Because of the possible high operating speed of the door curtains of 3 m/s, for example, it is feasible and generally not detrimental to the stocking or supplying operation, to close them in the interim. The energy losses can thus be even further reduced. At the same time it is further possible if one of the door curtains is damaged to continue operating the other one individually and using it establish an effective ancillary closure relative to insulation.

When this is done, the door curtains can comprise double-walled slats or strips, which can be filled with an insulating material. Thus, the door curtains can reliably develop the desired insulating effect, while keeping construction structurally simple. In this instance a foam plastic can be used as an additional insulating material.

Further, the open space between the two door curtains, that is, the thickness of the insulating air buffer, is preferably greater than 50 mm. It has been shown in practical experiments that such an insulating air buffer can effectively increase the resistivity of heat transfer of the gate arrangement. In particular, it is further proposed that the space between the two door curtains be greater than 150 mm and preferably greater than 250 mm. Generally, a thicker insulating air buffer reinforcingly contributes to increasing the resistivity of heat transfer, whereby the effect is increasingly diminished by the air circulation in the interface between the two door curtains. The optimal value for this dimension thus depends also on the conditions of deployment and in this case particularly on the regular temperature difference between the inside of the climate-controlled room and the surroundings and is adjusted accordingly.

It is further advantageous if the temperature of the insulating air buffer can be regulated. The dew point in the gate arrangement according to the invention can be predefined and relatively freely set, since the heat flux through the insulating effect of the door curtains is limited. This has the particular advantage that condensation processes at the gate arrangement can be selectively controlled. Any eventual ice formation can thus be extensively avoided. This applies both to the case wherein both door curtains are actuated together and to the case in which one single door curtain is used as a temporary rapid closure. When this is done, appropriate selection of the temperature of the insulating air buffer immediately before the stocking or supplying operation will establish the situation in such a manner that if at all possible no condensation will occur on the one continuously used door curtain. The external temperature and the humidity on the outside, the inside temperature and eventually the inside humidity can be used as parameters for calculating the heat requirement, at which condensation will be most extensively avoided, for controlling the temperature of the insulating air buffer. A further advantage of this embodiment is that the door curtains themselves can be maintained energy free, that is, no heating elements need to be arranged in the slats to prevent icing of the door curtain.

Accordingly, it is also further possible that air from the cooler, relative to air whose temperature is adjusted, side of the door be introduced into the insulating air buffer. This has the advantage that the air on the colder side of the door normally contains lower air humidity and thus condensation processes can be more easily avoided. The reliability of the gate arrangement according to the invention is further improved thereby.

I claim:

1. A gate arrangement for closure of a passageway between rooms with markedly different temperatures such as a passageway of a freezer-room, comprised of two door curtains arranged parallel to one another and each closing the passageway independently of one another, said door curtains border an insulating air buffer arranged between them, wherein at least one of the door curtains can be motor-driven at such a speed, that it is suitable as a temporary high-speed closure between successive passages or transits therethrough, and wherein the two door curtains together with the insulating air buffer develop the insulation effect required to maintain the desired cooling temperature.

2. A gate arrangement according to claim 1, wherein the door curtain facing the warmer side of the passageway serves as a temporary high-speed closure.

3. A gate arrangement according to claim 1, wherein the two door curtains can be motor-driven at such a speed that they are suitable as temporary high-speed closures of the passageway between successive passages therethrough, whereby both door curtains can be synchronously driven.

4. A gate arrangement according to claim 1, wherein the gate curtains have double-walled slats that may optionally be filled with an insulating material.

5. A gate arrangement according to claim 1, wherein the distance between the two gate curtains, that is the thickness of the insulating air buffer, is greater than 50 mm, particularly greater than 150 mm and preferably greater than 250 mm.

6. A gate arrangement according to claim 1, wherein the temperature of the insulating air buffer can be regulated.

7. A gate arrangement according to claim 6, wherein air adjusted with respect to the temperature can be introduced from the colder side of the gate into the insulating air buffer.
